(19) United States
(12) Patent Application Publication
(10) Pub. No.: US 2008/0007447 A1
(43) Pub. Date: Jan. 10, 2008

(54) Data relay for air vehicles and missiles

(76) Inventor: Christopher G. Vincent, Stevenage (GB)

Correspondence Address: NIXON & VANDERHYE, PC, 901 NORTH GLEBE ROAD, 11TH FLOOR, ARLINGTON, VA, 22203, US

(21) Appl. No.: 10/280,046

(22) Filed: Oct. 8, 2002

(30) Foreign Application Priority Data
Oct. 9, 2001 (GB) 0124245.2

(51) Int. Cl. F41G 7/00; G01S 13/00

(52) U.S. Cl. 342/62; 342/57; 342/58; 244/3.14

(57) ABSTRACT

A data relay system for relaying data between an air vehicle or missile and a command centre, the data relay system comprising at least one balloon, the balloon comprising a communications link to both the command centre and the air vehicle or missile. The invention further provides a method of relaying data between an air vehicle or missile and a command centre, the method comprising the steps of providing a balloon with a radio frequency transmitter and receiver unit and a power unit, deploying the balloon at high altitude such that the balloon is within the line-of-sight of the command centre and the air vehicle or missile, and using the balloon to relay radio frequency signals between the air vehicle or missile and the command centre. The invention further provides a second method of relaying data between an air vehicle or missile and a command centre, the method comprising the steps of providing a balloon with a radio frequency transmitter and receiver unit and a power unit, further providing the balloon with a fibre optic cable interface unit, wherein one end of a fibre optic cable is connected to the balloon, the other end being connected to an associated missile or air vehicle, deploying the balloon at high altitude such that the balloon is within the line-of-sight of the command centre, and using the balloon to relay data between the air vehicle or missile and the command centre, the balloon communicating with the command centre using radio frequency signals and communicating with the air vehicle or missile using the fibre optic cable. The invention also provides a missile comprising an inflatable bag, gas for inflating the inflatable bag, a radio frequency receiver and transmitter unit, and a power unit.

The present invention relates to a data relay for airborne vehicles and missiles.

In conflict situations it is sometimes desirable for airborne surveillance vehicles or missiles to be deployed to a target area which is at a distance of 100 km or more from the launch area. It is often necessary to communicate with missiles in flight, to aid its navigation to a target, and to redirect the missile to an alternative target if necessary. Also, two-way communication between an airborne surveillance vehicle and a ground station is desirable, to enable status monitoring and man-in-the-loop monitoring of the situation. Often there may be mountainous terrain between the target area and the launch site, making communication between the launch site and the air vehicle or missile difficult. A conventional method of communication between airborne surveillance vehicles or missiles and the launch site is using radio transmissions, however, these are hampered by mountainous terrain and also the curvature of the earth where the launch site is over 100 km from the target area.

One method of improving communications between an air vehicle or missile and the launch site involves providing a physical link, such as an optical fibre, between the air vehicle or missile and the launch site. The air vehicle or missile is launched to a high altitude so that the optical fibre does not trail on the ground, where it might be damaged.

A disadvantage of this method is that the air vehicle or missile has to fly relatively slowly, generally at speeds of less than 200 m/s, in order that the fibre optic cable is deployed correctly and does not break during unwinding as the air vehicle or missile flies away from the launch site. This is a particular problem for missiles, as they are capable of much higher flight velocities, and a slow flight increases the time available for the target to move out of range or to realise that it is under attack and to employ countermeasures against the missile.

Furthermore, to enable the link between the air vehicle or missile to remain in place during the flight time of the air vehicle or missile, it is necessary for the launch equipment, to which the fibre optic cable is attached, to remain stationary for the full duration of the flight. Whilst the launch equipment is stationary, it and its operatives are vulnerable to hostile countermeasures such as counterfire. Ideally, it is desirable for the launch equipment to be removed from the launch site and hidden as soon as possible after launching the air vehicle or missile, so that any return fire falls on empty ground. At present, this is not possible where a physical data link is used.

The present invention seeks to provide an improved data link between a ground station and an airborne surveillance vehicle or missile.

According to the present invention in one aspect thereof there is provided a data relay system for relaying data between an air vehicle or missile and a command centre, the data relay system comprising at least one balloon, the balloon comprising a communications link to both the command centre and the air vehicle or missile.

According to the present invention in another aspect thereof there is provided a method of relaying data between an air vehicle or missile and a command centre, the method comprising the steps of:

Providing a balloon with a radio frequency transmitter and receiver unit and a power unit, Deploying the balloon at high altitude such that the balloon is within the line-of-sight of the command centre and the air vehicle or missile,

Using the balloon to relay radio frequency signals between the air vehicle or missile and the command centre.

If the distance between the command centre and an intended target is great, then a plurality of balloons may be provided, each acting as a data relay and each being equipped with a radio frequency transmitter and receiver unit and a power unit.

The balloon may be deployed before the air vehicle or missile is launched. Alternatively the balloon may be attached to the air vehicle or missile and may be deployed at a desired point on the trajectory of the air vehicle or missile. The balloon may be capable of receiving and transmitting radio frequency signals received from a plurality of air vehicles or missiles. Preferably the balloon is capable of receiving and transmitting radio frequency signals received from a plurality of command centres.

According to the present invention in another aspect thereof there is provided a method of relaying data between an air vehicle or missile and a command centre, the method comprising the steps of:

Providing a balloon with a radio frequency transmitter and receiver unit and a power unit,

Further providing the balloon with a fibre optic cable interface unit, wherein one end of a fibre optic cable is connected to the balloon, the other end being connected to an associated missile or air vehicle,

Deploying the balloon at high altitude such that the balloon is within the line-of-sight of the command centre,

Using the balloon to relay data between the air vehicle or missile and the command centre, the balloon communicating with the command centre using radio frequency signals and communicating with the air vehicle or missile using the fibre optic cable.

If the distance between the command centre and an intended target is great, then a plurality of balloons may be provided, each acting as a data relay and each being equipped with a radio frequency transmitter and receiver unit and a power unit. In this case, the balloons communicate with each other using radio frequency transmissions, and one balloon communicates with the air vehicle or missile using a fibre optic cable.

According to the present invention in another aspect thereof there is provided a missile comprising a data relay system comprising an inflatable bag, gas for inflating the inflatable bag, a radio frequency receiver and transmitter unit, and a power unit.

The missile is adapted to deploy the data relay system during its flight. Advantageously the inflatable bag inflates automatically on deployment of the data relay system. The missile may also comprise a fibre optic cable, one end of which is attached to the missile throughout the flight of the missile, and the other end of which is attached to the data relay system.

If the distance between the command centre and an intended target is great, then the missile may comprise a plurality of data relay systems, each being equipped with an inflatable bag, gas for inflating the inflatable bag, a radio frequency receiver and transmitter unit, and a power unit. In this case, the data relay balloons communicate with each other using radio frequency transmissions, and one balloon communicates with the air vehicle or missile, using for example radio frequency transmissions or a fibre optic cable.

One missile may deploy one or more data relay systems for use by other missiles, where no physical contact between the missile and the data relay system is required, for example where communication is by radio frequency.

The present invention will now be described by way of example only and with reference to the following drawings:

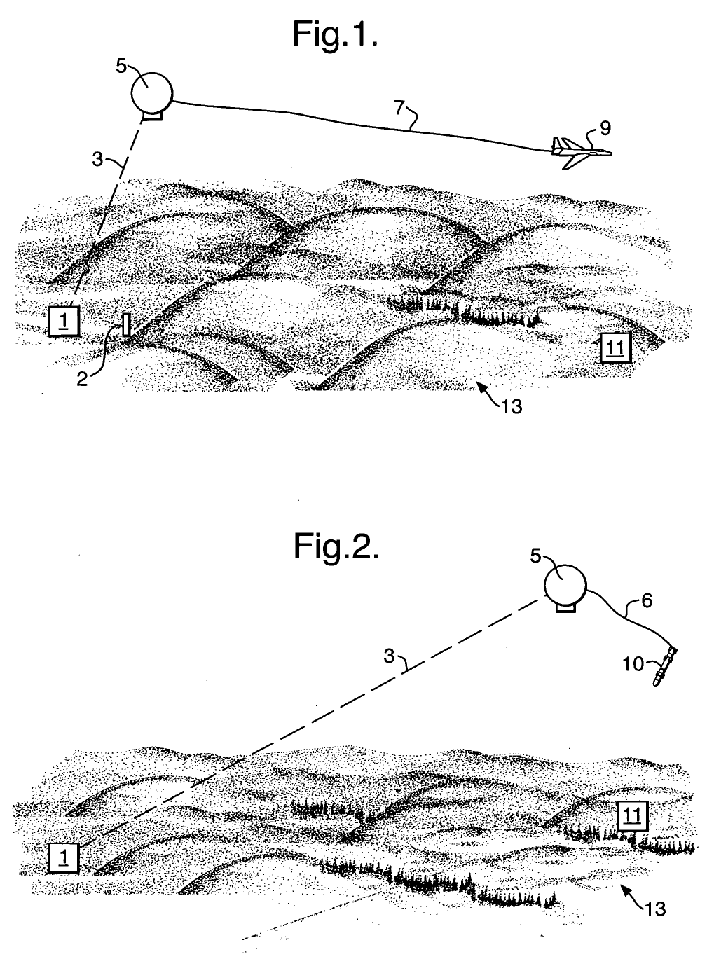

FIG. 1 shows a diagram of a first example of a data relay system in accordance with the present invention;

FIG. 2 shows a diagram of a second example of a data relay system in accordance with the present invention;

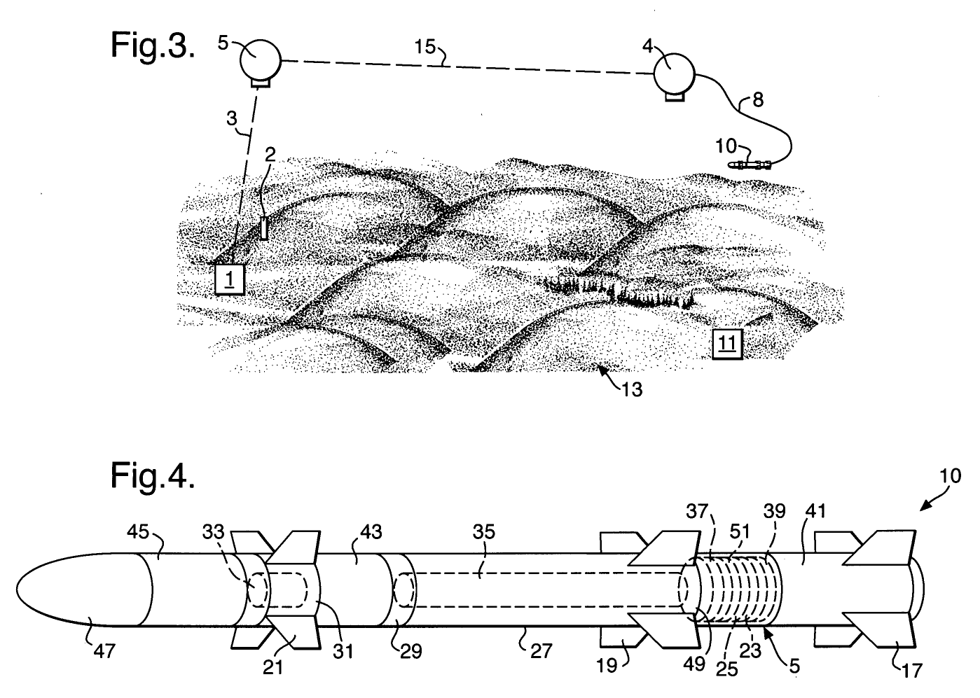

FIG. 3 shows a diagram of a third example of a data relay system in accordance with the present invention;

FIG. 4 shows a schematic view of a missile employing the data relay system of the present invention.

FIG. 1 shows a launch site 2 situated at a distance from a command centre 1. An unmanned air vehicle 9 is surveying the area around a potential target 11, and is relaying information relating to the target 11 and terrain 13 back to the command centre 1. The unmanned air vehicle is physically linked to a helium balloon 5 via a fibre optic cable 7, and the helium balloon 5 is able to communicate with the command centre 1 by means of a radio frequency (RF) link 3. In use, the unmanned air vehicle is launched from the launch site 2 and flies freely to a high altitude position where it releases the helium balloon 5. The helium balloon comprises a helium-filled bottle and a gas bag which is automatically inflated with the helium on deployment of the balloon from the air vehicle. The balloon also comprises a RF transmitter/receiver system, a power source, and an attachment point and interface for the fibre optic cable 7. After releasing the helium balloon, the air vehicle then flies on towards the potential target 11, trailing the fibre optic cable 7. The flight path may be preset in the air vehicle prior to take off. Alternatively the flight path may be controlled by the command centre 1 using the data relay system. The air vehicle 9 circles around the target area 11, acquiring images of the target 11 and surrounding terrain, and communicates this information back to the helium balloon 5 via the fibre optic cable 7. The helium balloon 5 relays this information back to the command centre 1 using its RF transmitter. If the command centre 1 wishes to communicate with the air vehicle 9, for example to change the flight path of the air vehicle 9, the command centre 1 transmits RF signals to the helium balloon 5, which relays the signals to the air vehicle 9 via the fibre optic cable 7.

The helium balloon preferably comprises a gas bag which is shaped to ensure that it turns into the prevailing wind and thereby minimises wind drag. The helium balloon then drifts in the prevailing upper atmosphere winds, allowing the data relay to remain at high altitude.

The balloon's RF transmitter antenna is preferably omni-directional, enabling RF communications to and from a relatively large area on the ground below the balloon. The omni-directional transmitter enables the command centre to detect the position of the balloon and the command centre can then direct a relatively narrow beam transmission to the balloon, thereby minimising transmission power and minimising the enemy's chance of locating the command centre. As the balloon's transmitter is omni-directional, several command posts in the vicinity of the balloon may also receive the transmissions from the balloon, and may thereby have immediate access to the information sent by the air vehicle. This also allows a different command post to take over the communication with the air vehicle in the event of damage occurring to the command centre. Also, the command centre may be mobile, as long as it stays within the range of the RF transmissions from the balloon.

As there is no physical connection between the launcher and the balloon, the launcher may be a mobile launcher which is moved into position to launch the air vehicle and is then hidden away to avoid damage by enemy return fire. Also, the launch site is advantageously situated at least several kilometres from the command centre, so that any return fire directed at the launch site does not affect the command centre.

Preferably the balloon's RF transmitter/receiver system is adapted to deal with compressed or encrypted data transmissions.

In the example of FIG. 1, the balloon is deployed at high altitude above the command centre area, and the air vehicle then flies towards the target area trailing the fibre optic cable. This means that the air vehicle is constrained to fly at relatively low speed to maintain the integrity of the fibre optic data link to the balloon. If a missile with a warhead were deployed instead of the air surveillance vehicle, then it would be advantageous for the missile to be able to fly at a faster speed towards the target. This is possible as explained with reference to FIG. 2.

FIG. 2 shows a missile 10 being directed at a target 11. The missile is fired from the vicinity of the command centre 1, but this time, it does not deploy the helium balloon above the command centre 1. Instead, it flies to a high altitude position above the target 11 before deploying the helium balloon 5. This allows the missile 10 to fly rapidly to the area of the target 11. As long as the command centre 1 can maintain a line-of-sight with the balloon 5, then the command centre and balloon can communicate with each other via a RF link 3. However, as the distance from the command centre to the balloon has increased compared to the example shown in FIG. 1, there is a need for greater power in the balloon's RF transmitter. This means that the balloon's power source will need to be larger and hence the balloon itself will need to be larger. The balloon will therefore be easier to detect by an enemy within the target area. Furthermore, the command centre uplink will also require more power to transmit RF signals to the balloon, and the signals will be transmitted at a lower incidence, both factors increasing the probability of the enemy locating the position of the command centre.

FIG. 3 shows a missile 10 which has been fired from a launch site 2. The missile 10 follows a preset trajectory, flying to a high altitude in the region of a command centre 1 where it deploys a balloon 5, the balloon being similar to those balloons described with reference to FIGS. 1 and 2. The missile then flies rapidly to a high altitude above the target 11, where it deploys a second balloon 4, the balloon 4 being similar to the balloon 5. The missile 10 then may fly directly to the target 11 or may loiter above the target 11 until it is commanded to attack. There is no fibre optic cable between the balloons 5 and 4. Instead a RF link is used which allows the missile 10 to fly at high velocity towards the target. There is a fibre optic link 8 between the balloon 4 and the missile 10, but the distance left to be travelled by the missile 10 is relatively small, so that the overall time for the missile to reach the target is not greatly restricted by the presence of the fibre optic link 8. In use, the command centre 1 transmits an RF signal to the first balloon 5, which relays this signal via a RF link to the second balloon 4. The fibre optic cable 8 is used to relay signals between the missile 10 and the second balloon 4. The missile 10 may be replaced by an unmanned air vehicle for surveillance purposes, and the RF links between the command centre 1, the first balloon 5 and the second balloon 4 are preferably two way to allow data to be sent back from the surveillance vehicle to the command centre 1. Each of the data relay balloons 4,5 are adapted to have a wide beamwidth coded beacon RF transmission to enable each balloon to locate and track the other. Each balloon also has a narrow beam tracking receive/transmit antenna for sending and receiving data transmissions. This minimises power requirements for data transmission between the balloons and allows the balloons to carry less weight and be therefore smaller and less detectable by an enemy. The balloon 5 further comprises a separate wide beam antenna for transmitting data to the command centre and any nearby command units which may also be required to receive data from a surveillance vehicle or missile.

Several other embodiments are foreseen, such as, for example, utilising RF signals in place of a fibre optic cable between the air vehicle or missile and the balloon. This allows the missile or air vehicle to fly greater distances using the balloon as an RF data link, and allows the missile or air vehicle to fly at maximum velocity without any concern about breaking a fibre optic link. However, the missile would have to carry a powerful RF transmitter and a suitable power source which would add weight to the missile and increase chances of detection. In this case, there must be a line of sight between the missile or air vehicle and the balloon.

Another example involves deploying one balloon at high altitude between the target area and the region of the command centre. If the distance between the target area and the command centre is not too great, and the terrain is not too mountainous, then one balloon will suffice as a relay, as long as there is a line of sight between the balloon and the command centre. In the case of a RF link between the balloon and the missile or air vehicle, then there must also be a line of sight between the balloon and the missile or air vehicle too.

FIG. 4 shows a schematic illustration of a missile 10 incorporating a data relay balloon arrangement suitable for deployment at high altitudes. The missile 10 comprises conventional stabilisation fins 19, control fins 21, and boost stabilisation fins 17, as well as actuators 31 for moving the control fins 21. The front part of the missile 10 is conventional, comprising a surveillance sensor 47, a digital signal processing unit 45, a GPS/lnertial Navigation System 33, an electronics pack 43, a power pack 29, and a cruise motor 35. In this example, a surveillance missile is shown, but a missile containing any kind of payload may be used. For example, an explosive payload may be carried just forward of the cruise motor 35. The missile 10 further comprises a fibre optic bobbin 27, on which a length of fibre optic cable is wound. The rear part of the missile comprises a boost motor 41, boost stabilisation fins 17, and a data relay balloon arrangement 5 comprising a helium bottle 39, and inflatable gas bag 37, a fibre optic interface unit 25, RF receiver/transmitter electronics (including antennae) 23 and a power unit 51. In use, the missile is launched and follows a pre-set trajectory (or is guided) to a high altitude, where the rear part of the missile 49 is detached. The boost motor 41 and boost stabilisation fins 17 fall away, and the balloon 5 is automatically deployed. The helium bottle 39 is used to fill the gas bag 37, and the fibre optic interface unit 25 retains one end of the fibre optic cable, the other end of the fibre optic cable being attached to the missile. As the missile 10 flies towards the target, the fibre optic cable is unwound from the fibre optic bobbin 27.

Further examples of the present invention may now suggest themselves to the reader skilled in the art. The scope of this patent is intended to cover any such examples which embody the spirit of the invention.

1. A data relay system for relaying data between an air vehicle or missile and a command centre, the data relay system comprising at least one balloon, the balloon comprising a communications link to both the command centre and the air vehicle or missile.

2. A data relay system as claimed in claim 1 wherein the data relay system comprises a plurality of balloons.

3. A data relay system as claimed in claim 1 or claim 2, wherein the or each balloon is equipped a radio frequency transmitter and receiver unit and a power unit.

4. A data relay system as claimed in any preceding claim wherein the balloon is capable of receiving and transmitting radio frequency signals received from a plurality of air vehicles or missiles.

5. A data relay system claimed in any preceding claim wherein the balloon is capable of receiving and transmitting radio frequency signals received from a plurality of command centres.

6. A method of relaying data between an air vehicle or missile and a command centre, the method comprising the steps of:
providing a balloon with a radio frequency transmitter and receiver unit and a power unit,
deploying the balloon at high altitude such that the balloon is within the line-of-sight of the command centre and the air vehicle or missile, using the balloon to relay radio frequency signals between the air vehicle or missile and the command centre.

7. A method of relaying data between an air vehicle or missile and a command centre as claimed in claim 6 wherein the balloon is deployed before the air vehicle or missile is launched.

8. A method of relaying data between an air vehicle or missile and a command centre as claimed in claim 6 wherein the balloon is attached to the air vehicle or missile and is deployed at a desired point on the trajectory of the air vehicle or missile.

9. A method of relaying data between an air vehicle or missile and a command centre, the method comprising the steps of:
providing a balloon with a radio frequency transmitter and receiver unit and a power unit,
further providing the balloon with a fibre optic cable interface unit, wherein one end of a fibre optic cable is connected to the balloon, the other end being connected to an associated missile or air vehicle,
deploying the balloon at high altitude such that the balloon is within the line-of-sight of the command centre,
using the balloon to relay data between the air vehicle or missile and the command centre, the balloon communicating with the command centre using radio frequency signals and communicating with the air vehicle or missile using the fibre optic cable.

10. A method of relaying data between an air vehicle or missile and a command centre as claimed in claim 9 wherein a plurality of balloons is provided each acting as a data relay and each being equipped with a radio frequency transmitter and receiver unit and a power unit, the balloons communicating with each other using radio frequency transmissions, and one balloon communicating with the air vehicle or missile using a fibre optic cable.

11. A missile comprising a data relay system comprising an inflatable bag, gas for inflating the inflatable bag, a radio frequency receiver and transmitter unit, and a power unit.

12. A missile comprising a data relay system as claimed in claim 11 wherein the missile is adapted to deploy the data relay system during its flight.

13. A missile comprising a data relay system as claimed in claim 11 or claim 12 wherein the inflatable bag is adapted to inflate automatically on deployment of the data relay system.

14. A missile comprising a data relay system as claimed in claim 11 or claim 12 or claim 13 wherein the missile comprises a fibre optic cable, one end of which is attached to the missile throughout the flight of the missile and the other end of which is attached to the data relay system.

15. A missile comprising a data relay system as claimed in any of claims 11 to 14 wherein the missile comprises a plurality of data relay systems, each being equipped with an inflatable bag, gas for inflating the inflatable bag, a radio frequency transmitter and receiver unit and a power unit, the data relay balloons communicating with each other using radio frequency transmissions, and one balloon communicating with the air vehicle or missile.
